(19) United States
(12) Patent Application Publication
(10) Pub. No.: US 2002/0173348 A1
(43) Pub. Date: Nov. 21, 2002

(54) Alarming device of a vehicle mobile phone hand-free device

(76) Inventor: Tuz-Fen Chen, Taipei (TW)

Correspondence Address: VARNDELL & VARNDELL, PLLC, 106-A S. COLUMBUS ST., ALEXANDRIA, VA, 22314, US

(21) Appl. No.: 09/858,976

(22) Filed: May 17, 2001

(51) Int. Cl. H04M 1/00

(52) U.S. Cl. 455/569; 455/573; 455/74

(57) ABSTRACT

An alarming device of a vehicle mobile phone hand-free device comprises a microprocessor, a power control circuit, a monitoring device, a mobile phone sensing device, and an alarming device. A mobile phone is installed to a car mobile phone seat having a hand-free device for sensing the mobile phone is placed in or taken out. The microprocessor causes the alarming device to alert the user by speech or lamp signal so as to inform the driver to place the mobile phone on the hand-free device before the car is actuated and take the mobile phone out as the driver leaves from the car. Therefore, the user may use the hand-free device to achieve the safety driving.

### FIELD OF THE INVENTION

The present invention relates to an alarming device of a vehicle mobile phone hand-free device. Thereby, the user can place a mobile phone on a hand-free device before driving, and take the mobile phone from the hand-free device after leaving from a car.

### BACKGROUND OF THE INVENTION

It is often the driver dial up a mobile phone in driving or receives a call when the driver is driving. However, if some emergency occurs, the driver can not take a proper action to avoid an accident. Thus, a great traffic accident occurs. Not only the life and asset of the driver has a great lose, but also it is very possible that other people are hurt in the accident.

Therefore, a mobile phone hand-free device is developed commercially. Thereby, the driver may dial up by speech and speech at another end is emitted from the stereo of the car so that the driver may hold the steering wheel as he or she is speaking. Therefore, the driver may take a proper action as accident occurs.

Conventionally, the driver hangs the mobile phone on the waist or in packet. Therefore, the driver often forgets to take the mobile phone to the hand-free device so that the driver is often very nervous as a call inputs. Or the driver dials up the mobile phone by hands. As a result, the hand-free device is not used so that the danger in driving remains.

### SUMMARY OF THE INVENTION

Accordingly, the primary object of the present invention is to provide an alarming device of a vehicle mobile phone hand-free device, wherein a microprocessor causes the alarming device to alert the user by speech or lamp signal so as to inform the driver to place the mobile phone on the hand-free device before the car is actuated and take the mobile phone out as the driver leaves from the car. Therefore, the user may use the hand-free device to achieve the safety driving.

Another object of the present invention is to provide an alarming device of a vehicle mobile phone hand-free device, wherein two monitoring device of the alarming device are installed to an electric switch and an engine firing signal. As the electric switch is on, the signal is transferred to the microprocessor by the monitoring device so that the alarming device promise the driver to place the mobile phone on the hand-free device. After the engine is extinguished, the monitoring device emits a signal to the microprocessor to inform the driver to take the mobile phone out of the car.

A further object of the present invention is to provide an alarming device of a vehicle mobile phone hand-free device, the alarming device is a speech or a lamp type.

To achieve above objects, the present invention provides an alarming device of a vehicle mobile phone hand-free device comprising: a microprocessor, a power control circuit, a monitoring device, a mobile phone sensing device, and an alarming device; wherein the microprocessor is a primary control center of the present invention, which has the functions of receiving a power of the power control circuit, signals of the monitoring device, and signals of the mobile phone sensing device; the power control circuit is connected between a power source and the microprocessor for selecting a power source of the alarming device; the monitoring device is connected between a car and the microprocessor, for monitoring a state of the car, thereby, the microprocessor and alarming device can emit message to inform the driver; the sensing device is installed between a hand-free device and the microprocessor for sensing whether a mobile phone is placed in the hand-free device; and the alarming device is connected to the microprocessor and then the microprocessor emits an alarm to inform the user. As the car starts to move, the microprocessor causes the alarming device to alert the user by speech or lamp signal so as to inform the driver to place the mobile phone on the hand-free device before the car is actuated and take the mobile phone out as the driver leaves from the car. Therefore, the user may use the hand-free device to achieve the safety driving.

The microprocessor is replaced by a simulating lump circuit, and a signal analyzing unit and a recorder of such as a memory or a buffer is installed. The signal analysis unit serves to receive signal from the monitoring device and the sensing device. Then the recorder controls the alarming device to emit alarms.

The power control circuit is connected to the microprocessor and has two power input selecting portions, one is connected to a battery of a car and another is connected to a cigar-lighter; and a voltage regulating circuit and an automatic switch.

The power control circuit is built in an auxiliary power source connected to a standby battery for performing an alerting function as the car is stopped or the electric switch is closed.

The alarming device includes a wavelet monitoring circuit, an automatic switch and an amplifier; the automatic switch is connected to a car engine firing signal source and a car cigar lighter for automatically selecting to sense one of the two devices; the wavelet monitoring circuit is connected to the microprocessor through the amplifier for sensing the condition within the car so as to know the behavior of the driver so that the alarming device emits an alarm to inform the user.

The monitoring device is installed with a wavelet monitoring circuit for being installed to a cigar lighter of a car, and then is connected between the microprocessor and the simulating lump circuit.

The monitoring device is installed with a wavelet monitoring circuit for being coupled to an engine firing signal of a car, and then is connected between the microprocessor and the simulating lump circuit.

The alarming device is a speech alerting device, which comprises a speech lump current for storage premise sound and a set of amplifiers for actuating a car speaker.

The alarming device is a lamp alarming device.

The alarming device is formed by a speech alarming device and a lamp alarming device; the speech alarming device includes a speech lump circuit for storing promising speech and a set of amplifier for pushing a trumpet of a car.

The lamp alarming device uses a bulb or an LCD for alerting the user.

The mobile phone sensing device is triggered mechanically or electrically for detecting whether a mobile phone is placed in the hand-free device.

A non-contact switch is used in the automatic detection circuit.

The sensing device is installed with a connector for being inserted into a coupled charging connected of a mobile phone.

The alarming device is wholly installed in a car so as to be a component of the car so as to have an alert function.

The alarming device is an external device externally to a car. Thereby, the user may external connect the alarming device to the car.

An alarming device of a vehicle mobile phone hand-free device comprises a microprocessor, a power control circuit, a monitoring device, a mobile phone sensing device, and an alarming device. A mobile phone is installed to a car mobile phone seat having a hand-free device for sensing the mobile phone is placed in or taken out. The microprocessor causes the alarming device to alert the user by speech or lamp signal so as to inform the driver to place the mobile phone on the hand-free device before the car is actuated and take the mobile phone out as the driver leaves from the car. Therefore, the user may use the hand-free device to achieve the safety driving.

The various objects and advantages of the present invention will be more readily understood from the following detailed description when read in conjunction with the appended drawing.

### BRIEF DESCRIPTION OF THE DRAWINGS

FIG. 1 is a schematic view of the alarming device in the present invention.

FIG. 2 shows the circuit of the alarming device of the present invention.

FIG. 3 is a schematic view showing that the sensing device of the present invention is installed to the hand-free device.

FIG. 4 is a schematic view showing that sensing device of the present invention has a plug.

FIG. 5 shows the principle of the control circuit of the alarming device in the present invention.

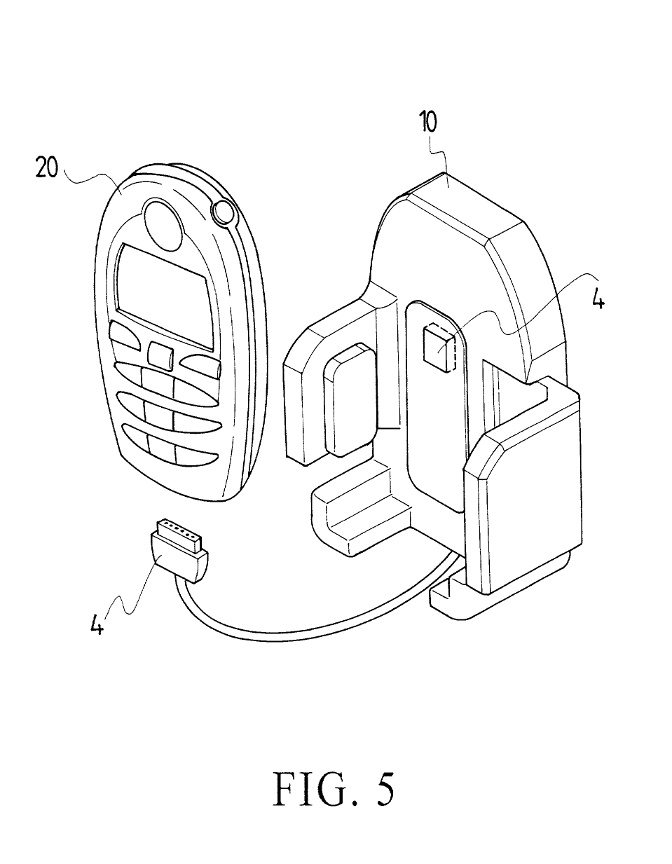

### DETAILED DESCRIPTION OF THE PREFERRED EMBODIMENTS

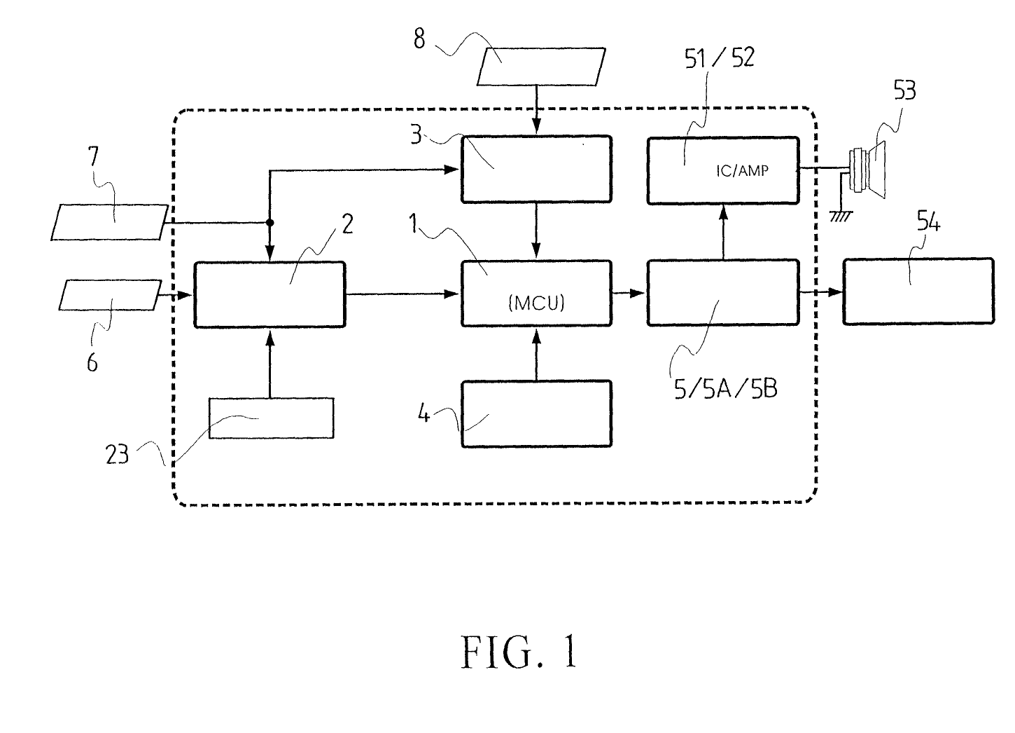

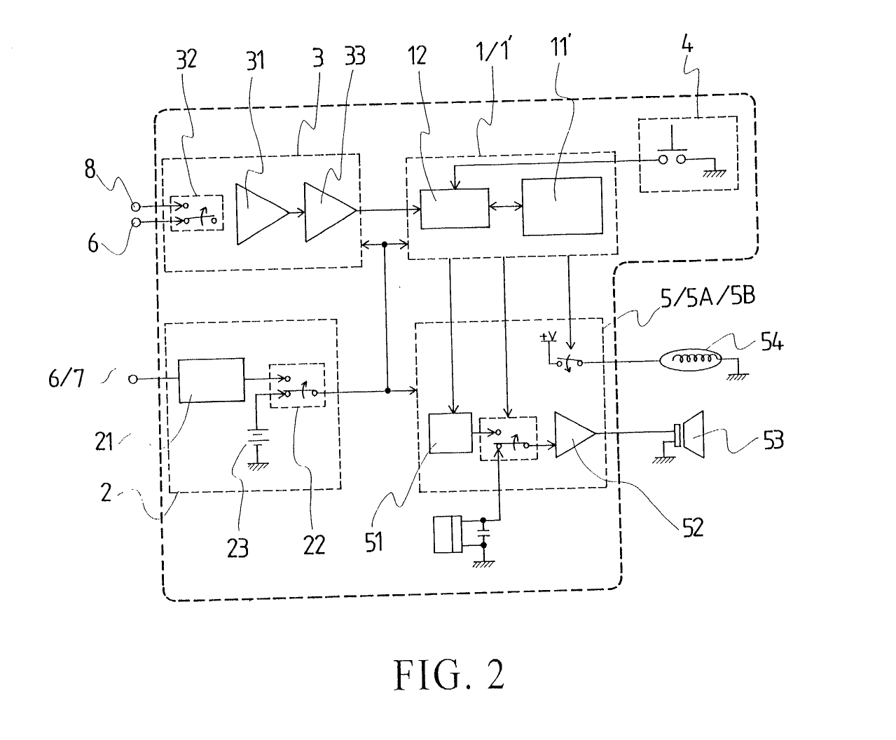

Referring to FIGS. 1 and 2, the alarming device of a vehicle mobile phone hand-free device of the present invention is illustrated. The alarming device of a vehicle mobile phone hand-free device of the present invention includes a microprocessor (MCU) 1, a power control circuit 2, a monitoring device 3, a mobile phone sensing device 4, and an alarming device 5. The microprocessor (MCU) 1 is a primary control center of the present invention, which has the functions of receiving the power of the power control circuit 2, signals of the monitoring device 3, and signals of the mobile phone sensing device 4. It is set as the microprocessor (MCU) 1 receives the signal of the monitoring device 3, then the alarming device 5 is informed to emit a message to alert the driver to place the mobile phone 20 or take it from the hand-free device 10. Then the mobile phone sensing device 4 on the hand-free device 10 emits a signal, the microprocessor (MCU) 1 receives the signal and then stop the alarming device 5. However, a simulating lump circuit (ECU) 1′ can be used herein (referring to FIG. 2). It is further installed with a recording unit 11′ having a storage device or a buffer and a signal analysis unit 12′. The signal analysis unit 12′ receives the signals from the monitoring device 3 and mobile phone sensing device 4. Then, the recording unit 11′ controls the alarming device to emit an alert.

The power control circuit 2 is a control circuit for receiving power of the alarming device. The power control circuit 2 is connected to the microprocessor (MCU) 1 or the simulating lump circuit (ECU) 1′. The power control circuit 2 primarily has two power input selection portion. Thereby, the user selects one set to be connected to the battery 6 of a car. The another set is connected to the cigar lighter 7. Thereby, regulating lump circuit 21 and an automatic switch 22 selects power. Two sets of power input selection portions are used to be installed at the battery 6 or the cigar lighter 7. The present invention can be used only to a battery 6 or a cigar lighter 7, thus, the applications being not confined. The power control circuit 2 can be built with an auxiliary power source therein. The auxiliary power source is connected to a standby power source 23. As the car is distinguished or the electric switch is closed, the present invention remains have the alerting function.

The monitoring device 3 is used to monitor the condition of a car so that the microprocessor (MCU) 1 and the alarming device 5 are used to alert the driver. The alarming device includes a wavelet monitoring circuit 31, an automatic switch 32 and an amplifier 33. The automatic switch 32 is connected to a car engine firing signal source 8 and a car cigar lighter 7 for automatically selecting to sense one of the two devices. The wavelet monitoring circuit 31 is connected to the microprocessor (MCU) 1 or the simulating lump circuit (ECU) 1′ through the amplifier 33. It can sense whether the doors of a car is opened or closed so as to know the behavior of the driver so that the alarming device of the present invention emits an alert message. Or as the engine of a car is actuated or distinguished, it can sense the condition of the car so as to know the behavior the driver so that the alarming device alerts the user. The present invention can is installed with a wavelet monitoring circuit 31 for being connected to the cigar lighter 7 or the engine firing signal 8 of the car. It is connected between the microprocessor 31 and the simulating lump circuit (ECU) 1′ so as to achieve the aforesaid sensing function.

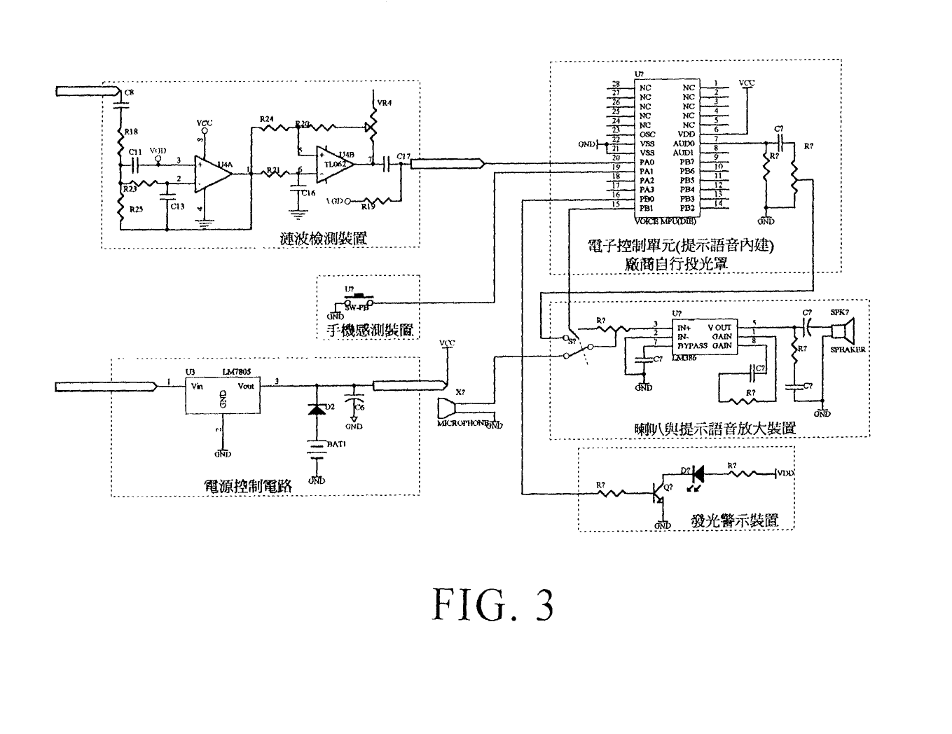

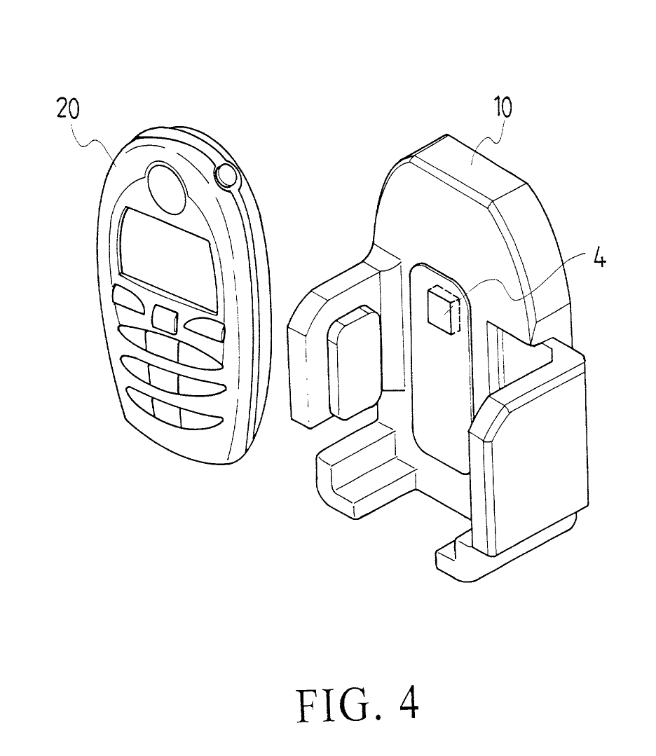

The mobile phone sensing device 4 serves to sense whether the mobile phone 20 is placed in the hand-free device 10. It can be installed at the hand-free device 10 of a car mobile phone and is connected to the microprocessor 1 of the simulating lump circuit 1′. The mobile phone sensing device can be triggered mechanically (for example, by a pressable switch or an elastic switch) or triggered electronically (for example, electronic switch by a transmitting shielding device, reflective shielding device, photo sensitive resistor, etc) or non-triggered type switch (for example, reed switch). The mobile phone sensing device 4 is installed to the mobile phone hand-free device 10 for sensing in moving (referring to FIG. 3). Furthermore, it can be installed to a plug to be inserted to the receptacle of the mobile phone 20 (referring to FIG. 4). A sensing effect is acquired by the monitored voltage value.

An alarming device is a speech alerting device, which comprises a speech lump current 51 for storage premise sound and a set of amplifiers 52 for actuating car speaker 53 to emit sound to alert the driver. Furthermore, a lamp alarming device SA can be used to replace or substitute the speech alarming device 5A. The lamp alarming device 5A may be used a bulb or an LED light emitter 54 being installed at any place or built in a meter so as to generate light message to alter the driver.

By the alarming device of a vehicle mobile phone hand-free device of the present invention including a microprocessor (MCU) 1, a power control circuit 2, a monitoring device 3, a mobile phone sensing device 4, and an alarming device 5, the whole structure of the present invention can be built in a car so as to be formed as equipment of the car. Thereby, a lamp alarm is generated by the meter panel of the car, or a speech alert is emitted from the trumpet of a car. The present invention can be independent as an external alarming device, namely it is made as an independent object. Thereby, the user may externally connect it to a car for use.

If so, when the a drive enters into a car, then actuates power source and starts the engine, the wavelet monitoring circuit 31 of the monitoring device 3 may sense that the car is repaired to move by sensing the cigar lighter 7 or the engine filing signal 8. Then, this signal is transferred to the microprocessor (MCU) 1 or the simulating lump circuit (ECU) 1 through the amplifier 33. This signal is analyzed by a signal analyzing unit, then it is known that the driver prepares to drive the car. The microprocessor 1 or the simulating lump circuit (ECU) 1′ control the alarming device 5 to emit lamp signal or voice to alert the driver to place the mobile phone 20 at the car hand-free device 10. When the mobile phone 20 is placed in a right way, then the sensing device 4 generates a cut off function and the alarming device is stopped. Thereby, the user is not necessary to search for a mobile phone in the body or packet due to a sudden calling. Therefore, the driver may dedicate in the driving.

When the user prepares to leave from the car so as to close the engine or electric switch, in the present invention, the state of a car can be monitored by the wavelet monitoring circuit 31 of the monitoring device 3. And therefore, the action of the user to be left from the car can be obtained. Then the microprocessor 1 or simulating lump circuit 1′ control the alarming device 5 to emit light or speech to alert the driver to take off the mobile phone 20. As the mobile phone 20 is taken out, the alarming device is stopped by the cut-off function of the sensing device 4. Thereby, the problem that the mobile phone is left in the car frequently can be resolved so as to have a safety and practical use.

The present invention are thus described, it will be obvious that the same may be varied in many ways, such as the lamp alarming device 52 or the speech alarming device 51. Such variations are not to be regarded as a departure from the spirit and scope of the present invention, and all such modifications as would be obvious to one skilled in the art are intended to be included within the scope of the following claims.

What is claimed is:

1. An alarming device of a vehicle mobile phone hand-free device comprising: a microprocessor, a power control circuit, a monitoring device, a mobile phone sensing device, and an alarming device; wherein the microprocessor is a primary control center of the present invention, which has the functions of receiving a power of the power control circuit, signals of the monitoring device, and signals of the mobile phone sensing device; the power control circuit is connected between a power source and the microprocessor for selecting a power source of the alarming device; the monitoring device is connected between a car and the microprocessor, for monitoring a state of the car, thereby, the microprocessor and alarming device can emit message to inform the driver; the sensing device is installed between a hand-free device and the microprocessor for sensing whether a mobile phone is placed in the hand-free device; and the alarming device is connected to the microprocessor and then the microprocessor emits an alarm to inform the user.

2. The alarming device of a vehicle mobile phone hand-free device as claimed in claim 1, wherein the microprocessor is replaced by a simulating lump circuit, and a signal analyzing unit and a recorder of such as a memory or a buffer is installed.

3. The alarming device of a vehicle mobile phone hand-free device as claimed in claim 1, wherein the power control circuit is connected to the microprocessor and has two power input selecting portions, one is connected to a battery of a car and another is connected to a cigar-lighter; and a voltage regulating circuit and an automatic switch.

4. The alarming device of a vehicle mobile phone hand-free device as claimed in claim 1, wherein the power control circuit is built in an auxiliary power source connected to a standby battery.

5. The alarming device of a vehicle mobile phone hand-free device as claimed in claim 1, wherein the alarming device includes a wavelet monitoring circuit, an automatic switch and an amplifier; the automatic switch is connected to a car engine firing signal source and a car cigar lighter for automatically selecting to sense one of the two devices; the wavelet monitoring circuit is connected to the microprocessor through the amplifier.

6. The alarming device of a vehicle mobile phone hand-free device as claimed in claim 5, wherein the monitoring device is installed with a wavelet monitoring circuit for being installed to a cigar lighter of a car, and then is connected between the microprocessor and the simulating lump circuit.

7. The alarming device of a vehicle mobile phone hand-free device as claimed in claim 5, wherein the monitoring device is installed with a wavelet monitoring circuit for being coupled to an engine firing signal of a car, and then is connected between the microprocessor and the simulating lump circuit.

8. The alarming device of a vehicle mobile phone hand-free device as claimed in claim 1, wherein an alarming device is a speech alerting device, which comprises a speech lump current for storage premise sound and a set of amplifiers for actuating a car speaker.

9. The alarming device of a vehicle mobile phone hand-free device as claimed in claim 1, wherein the alarming device is a lamp alarming device.

10. The alarming device of a vehicle mobile phone hand-free device as claimed in claim 1, wherein the alarming device is formed by a speech alarming device and a lamp alarming device; the speech alarming device includes a speech lump circuit for storing promising speech and a set of amplifier for pushing a trumpet of a car.

11. The alarming device of a vehicle mobile phone hand-free device as claimed in claim 9 or 10, wherein the lamp alarming device uses a bulb.

12. The alarming device of a vehicle mobile phone hand-free device as claimed in claim 9 or 10, wherein the lamp alarming device uses LCD.

13. The alarming device of a vehicle mobile phone hand-free device as claimed in claim 1, wherein the mobile phone sensing device is triggered mechanically for detecting whether a mobile phone is placed in the hand-free device.

14. The alarming device of a vehicle mobile phone hand-free device as claimed in claim 1, wherein the mobile phone sensing device is triggered electrically for detecting whether a mobile phone is placed in the hand-free device.

15. The alarming device of a vehicle mobile phone hand-free device as claimed in claim 1, wherein a non-contact switch is used in the automatic detection circuit.

16. The alarming device of a vehicle mobile phone hand-free device as claimed in claim 1, wherein the sensing device is installed with a connector for being inserted into a coupled charging connector of a mobile phone.

17. The alarming device of a vehicle mobile phone hand-free device as claimed in claim 1, wherein the alarming device is wholly installed in a car so as to be a component of the car.

18. The alarming device of a vehicle mobile phone hand-free device as claimed in claim 1, wherein the alarming device is an external device externally to a car.
